(19) United States
(12) Patent Application Publication
(10) Pub. No.: US 2022/0371286 A1
(43) Pub. Date: Nov. 24, 2022

(54) Method of manufacturing a particle foam part

(71) Applicant: Kurtz GmbH & Co. KG, Kreuzwertheim (DE)

(72) Inventors: Harald Sommer, Hasloch (DE); Victor Romanov, Wertheim (DE); Uwe Rothaug, Marktheidenfeld (DE)

(21) Appl. No.: 17/767,175

(22) PCT Filed: Oct. 5, 2020
(86) PCT No.: PCT/EP2020/077856

§ 371 Date: Apr. 7, 2022

(30) Foreign Application Priority Data
Oct. 15, 2019 (DE) 10 2019 127 721.3

(51) Int. Cl. B29C 67/20; B29C 44/44; B29C 35/08; C08J 9/232

(52) U.S. Cl. CPC B29C 67/205; B29C 44/445; B29C 35/0805; C08J 9/232; B29K 2105/251

(57) ABSTRACT

The invention concerns a process and a device for producing a particle foam part. The method comprises the steps of
feeding foam particles into a mould space of a mould,
welding the foam particles in the mould space under application of a predetermined pressure, wherein the foam particles comprise
a proportion of at least 10% by weight of recycled, shredded foam particles and the welding of the foam particles takes place by means of electromagnetic waves.

The present invention concerns a process for producing a particle foam part.

Products made of plastic, such as particle foam parts, which are only used once, such as packaging, are considered to be harmful to the environment. Such plastic parts are increasingly being replaced by parts made of other materials. There is therefore a considerable need to make particle foam parts more environmentally friendly. Environmental performance can be improved if a significant proportion of the material can be recycled.

For particle foam parts made of expanded thermoplastic polystyrene (ePS), there is already a recycling rate of up to 10%. This means that in the manufacture of a particle foam part, up to 10% of the raw material is recycled material.

Recycled particle foam parts are shredded and mixed with new material. In the following, recycled, shredded particle foam material is referred to as “regrind” and non-recycled foam particles are referred to as “originate”. The term originate therefore refers to foam particles which have not yet been or are not yet welded together to form a particle foam part. The foam particles of originate have a closed surface. They can also be filled with a propellant. When the material is heated, the air entrapped in the material or the blowing agent contained therein expands so that the walls of adjacent foam particles press against each other when heated and can be welded together to form a particle foam part.

Particles which are made by the shredding of particle foam parts may include several foam particles (also described as beads) originally welded together, which are still closed after shredding. When heated again, these particles may expand once more.

The particles may also be shredded to the extent that the original foam particles (beads) are isolated, generally causing the surface of the individual particles to be damaged. In the following, such heavily shredded particles are described as recycled, shredded foam particles (regrind) which usually do not have a closed surface. They therefore do not expand when heated. A small proportion of recycled, shredded particle foam parts does not affect the production of a particle foam part.

If, however, you want to increase the proportion of recycled material, then when the foam particles are welded to the particle foam part, there is not the necessary pressure with which the foam particles have to press against each other to enable uniform welding. With a proportion of regenerated material of more than 10%, the problem with conventional production processes is that the welding of the particles does not take place in certain areas, so that there are sections on the finished particle foam part which are not correctly welded. The foam particles then form loose crumbs in the particle foam part.

To counteract this, internal tests have been carried out in which external pressure is applied to the foam particles so that they are pressed together to a sufficient extent. It has been shown that with a proportion of significantly more than 10% of recycled material, a pressure of around 5 bar is advisable in order to achieve satisfactory welding. However, this has the disadvantage that the contact surface of the foam particles is larger by nature. As a result, steam that is introduced into a mould cavity for welding the foam particles cannot penetrate the edge area of the mould cavity sufficiently. This causes the foam particles at the edges to be welded more strongly than at the centre. This in turn leads to low quality particle foam parts due to poor welding in the centre.

If you want to increase the amount of regenerated material, then you have shredded, pressed and extruded particle foam parts to be recycled. This produces foam particles from recycled material and with a closed surface. This will help to overcome the problems outlined above. However, in order to be able to re-extrude recycled material, additives must be added. These additives are expensive. Furthermore, there is a risk that the foam particles produced in this way are contaminated and are of poorer quality than foam particles produced from non-recycled material.

At the end of the 90's, the company Erlenbach GmbH & Co. KG offered a so-called “regeneration unit” with which recycled foam particles could be processed, for welding into a new particle foam part. In this treatment process, under the effects of heat and mechanical pressure, recycled foam particles are once again made round and smooth. This involves the particles being heated to the softening temperature and then made round by mechanical means. With this process an attempt is made to close the surface of the recycled foam particles, so that the latter are once again suitable for foaming and have similar properties to an originate. In practice, however, this treatment process has not proved successful, even though there is a considerable demand for the processing of regenerate.

Processes and devices for the production of particle foam parts from foam particles by means of saturated dry steam are described, for example, in WO 2014/128214 A1.

Methods and devices for welding foam particles to particle foam parts with electromagnetic waves have been known for a long time and can be found, for example, in U.S. Pat. Nos. 3,060,513, 3,242,238, GB 1 403 326, U.S. Pat. No. 5,128,073 and WO 2018/10 01 541 A1.

DE 103 28 896 A1 relates to a device and a method for the production of parts from particle foams in combination with fibres and/or granules by mixing foam particles with fibres and/or granules. Moulded part production is effected through welding using hot steam, or welding by means of electromagnetic waves. Here the foam particles may be recyclate. Used for the foam particles are preferably expanded polypropylene particle foam (ePP), polystyrene particle foam (EPS), polyethylene particle foam (EPE) or foam particles obtained by means of shredding from cross-linked and uncrosslinked polyolefin foam sheets or panels (XPP). Used as fibres are natural, mineral or synthetic fibres or polymer-coated fibres or co-polymers.

WO 2011/064 230 A1 describes a coating compound in which foam bodies are made from foam particles coated with it. After coating and drying of the foam particles, a compound of these is obtained by compression with steam and/or microwaves in a mould or by sintering. Used for the foam are for example pre-foamed, expandable polystyrene particles (ePS) or polypropylene particles (ePP). These may comprise up to 100% recycled material. The coating compound contains a ceramic material, possibly an alkali silicate, possibly a filming polymer and additional nanoscale SiO₂ particles, and should give the foam body produced adequate flame and heat resistance and sufficient water resistance.

DE 10 2016 100 690 A1 discloses a device and a method for the production of a particle foam part in which foam particles are heated in a mould by electromagnetic waves and welded into a particle foam part. Used for the foam particles for example are polyurethane (PU), polylactate (PLA), polyethylene block amide (PEBA), or polyethylene enterephthalate (PET). These materials absorb the electromagnetic waves well, so that heat transfer media (e.g. water) are not required.

DE 10 2009 028 987 A1 discloses a device and a method for the production of a foam block, comprising a mould cavity which may be filled with granules for moulding the foam block. The granules are compressed in the mould cavity by hot steam. In addition, the granules are usually of plastics such as polystyrene or polyolefins such as polyethylene and polypropylene, which are foamed (EPS, EPE or EPP), wherein the granules may also contain a portion of recyclate. The mould cavity is characterised in that it has two walls which may be moved along an axis and define the volume of the mould cavity.

DE 43 08 764 A1 relates to particle foam parts based on olefin polymerisates (ethylene-propylene copolymers) with compacted and smooth outer skin, and a device and method for their production. The moulded parts are welded with hot steam and under pressure. Also described is how the olefin polymerisates may be produced. They may be comprised to a large extent of recyclate particles (up to 50% by weight).

The invention is based on the task of creating a process and a device with which recycled, shredded foam particles with a high proportion of regenerated material can be easily and reliably welded in high quality.

The task is solved by the independent patent claims. Advantageous designs are indicated in the respective dependent claims.

A method of manufacturing a particle foam part according to the invention comprises the steps of
feeding foam particles into a mould cavity of a mould, and
Welding the foam particles in the mould space under application of a predetermined pressure, wherein the foam particles comprise a proportion of at least 10% by weight of recycled, shredded foam particles (regenerate) and the welding of the foam particles is effected by means of electromagnetic waves.

The inventors of this invention have recognized that, when welding the foam particles by means of electromagnetic waves, any pressure can be applied to the foam particles without impairing the welding of the foam particles, since the electromagnetic waves completely penetrate the foam particles and heat them from the inside out. Depending on the quality, size and proportion of the regenerate, the pressure can be adjusted so that there is sufficient contact between adjacent foam particles in the mould cavity.

With the method according to the invention, so-called moulded parts may be produced. In the production of particle foam parts, a distinction is made between moulded parts and blocks. DE 10 2009 028 987 A1 relates to a device and a method for production of a foam block. Such a block is generally a large cube with edge lengths in the range of 1 m and above. After production of such a block, it is generally cut into individual sheets, which may be used for example as insulation panels for buildings. The used of shredded foam particles on the manufacture of such blocks has long been known. These shredded foam particles are lumps of several foam particles (beads) originally welded together. The majority of the foam particles found in the lumps have a closed surface, so that they expand again under renewed heating.

Moulded parts on the other hand are usually smaller bodies which have a three-dimensional moulded surface. They often have intricate sections. With moulded parts, the surface quality requirement is significantly higher than for foam blocks. Moulded parts should have a smooth, even surface. No lumps may be used in the production of moulded parts, as is the case in the production of foam blocks. The method according to the invention is suitable for the production of moulded parts, since recycled, shredded foam particles, which generally do not have a closed surface, may be used. These recycled, shredded foam particles no longer expand under renewed heating. They may therefore not be used in a conventional process, in which the foam particles are welded by steam. The method according to the invention slows the production of moulded parts with intricate structures and smooth surfaces, with a considerable amount of recycled, shredded foam particles being used. Intricate structures for the purposes of the present application are for example walls with a wall thickness of no more than 1 cm.

The invention may also be used for the reliable production of moulded parts with thick sections. With conventional methods, in which steam is used, the passage of steam is problematic, especially in the case of thicker sections, when the mould cavity is put under pressure. To be understood as thicker sections are sections with a thickness of at least 3 cm, in particular at least 5 cm, and preferably at least 8 cm.

Thus, with the method according to the invention, moulded parts with any desired geometry may be may be made with good quality, while using a considerable proportion of recycled, shredded foam particles (regenerate).

The term “welding of foam particles” describe a process step in which the surface of the foam particles softens sufficiently that they fuse together. Here the foam particles fuse directly with one another, without the need for an additional binder. With the method according to the invention it is therefore not necessary to use a binder to bond the foam particles, and preferably also no binder is used.

Tests carried out by the applicant have shown that there is hardly any loss of quality when welding particle foam parts made of ePS up to a proportion of about 60% by weight of recycled, shredded foam particles (regenerate). This is very surprising, as a significant problem is solved in a very simple way.

Polystyrene hardly absorbs electromagnetic waves. To weld foam particles from ePS using electromagnetic waves, a heat transfer medium, such as water, is added which absorbs the electromagnetic waves. This causes the foam material to be indirectly heated by the electromagnetic waves. At a regenerate content of 70% and more, the particle foam parts contained a high undesirable residual moisture.

For materials such as polyurethane (eTPU), which absorb electromagnetic waves better than polystyrene, it is not necessary to add a heat transfer agent for welding. The problem of residual moisture does not exist with these materials, so that even particle foam parts with a proportion of more than 70% regrind can be reliably produced with high quality.

The proportion of recycled, shredded foam particles may be at least 20% by weight and in particular at least 30% by weight or at least 50% by weight or at least 70% by weight.

The predetermined pressure in the moulding chamber is preferably at least 2 bar, in particular at least 3 bar, and can also be set to at least 5 bar. The higher the pressure, the greater the amount of recycled shredded foam particles can be set and/or the more shredded the recycled material can be.

The electromagnetic waves are preferably electromagnetic RF radiation. The electromagnetic RF radiation shall preferably have a frequency of at least 30 KHz or at least 0.1 MHz, in particular at least 1 MHz or at least 2 MHz and preferably at least 10 MHz.

Electromagnetic RF radiation preferably has a maximum frequency of 300 MHz.

The generator for generating electromagnetic waves preferably generates electromagnetic waves with an amplitude of at least 10³ V and in particular at least 10⁴V. Commercial generators generate RF radiation with a frequency of 27.12 MHz.

The electromagnetic waves can also be microwaves in the frequency range of 300 MHz to 300 GHz.

The foam particles can be based on ePS (expandable polystyrene) or ePP (expandable polypropylene). These two materials absorb only a small amount of electromagnetic radiation. It is therefore advisable to add a dielectric heat transfer medium, such as water, during welding.

The foam particles can also be formed from other expandable thermoplastics, especially those that absorb electromagnetic waves well.

Foam particles based on polyurethane (ePU), polyether block amide (ePEBA), polylactate (PLA), polyamide (ePA), polybutylene terephthalate (ePBT), polyester ether elastomer (eTPEE) or polyethylene terephthalate (ePET) can also be used. Such materials absorb electromagnetic waves well, so that foam particles from these materials can be welded by means of electromagnetic waves without the addition of a heat transfer medium. This applies in particular to the use of RF radiation, which can be used to irradiate mould spaces up to a few metres in size evenly with electromagnetic waves.

The materials which absorb electromagnetic radiation well, especially RF radiation, each have a functional group (here: amide group, urethane group or ester group) which causes a dipole moment. These functional groups are responsible for the molecules absorbing the electromagnetic radiation. Therefore also other thermoplastics, which have such functional groups causing a dipole moment, are suitable to be welded with electromagnetic radiation, especially RF radiation.

The recycled, shredded foam particles can be mixed with non-shredded foam particles in a predetermined ratio using a mixing device and fed to the forming tool. Using such a process, the proportion of recycled, shredded foam particles can be freely adjusted and quickly varied.

Furthermore, recycled particle foam material can be shredded and then fed into the mould space.

According to another aspect of the invention, a device is provided for producing a particle foam part, comprising
a mould defining a mould space,
means for applying a predetermined pressure to foam particles located in the mould space, and
a generator for generating electromagnetic waves for welding the foam particles in the mould space.

This device is characterized by a mixing device for mixing recycled, shredded foam particles and non-recycled and non-shredded foam particles and/or a shredding device for shredding foam material to be recycled is provided.

By providing the mixing device, it is possible to feed individual ratios of recycled, shredded foam particles (=regenerate) and non-recycled and non-shredded foam particles (=originate) into the mould and to vary these ratios quickly. The shredding device allows the feeding of particle foam parts to be recycled, which are shredded to a size of foam particles suitable for re-welding. In particular, the shredding device is adjustable in such a way that foam particles of predetermined size can be shredded in a targeted manner.

A sorting device may be provided, which sorts the regenerate, so as to remove impurities. As impurities, dirt and/or material which is not homogenous may be segregated.

The sorting device may be arranged downstream in the process sequence of the shredding device. It is however also possible to provide a sorting device which is independent of a shredding device and with which already-shredded recycled material, delivered from outside, is sorted and then fed to the moulding tool.

Such a sorting device is disclosed in the as yet unpublished German patent application DE 10 2019 127 708.6.

The means for applying a predetermined pressure to foam particles in the mould cavity may be a press which compresses a mould consisting of two mould halves to produce the pressure in the mould cavity. This device may, however, also include a pump by means of which carrier gas with which foam particles are conveyed into the mould space and the mould space is thereby set under a predetermined pressure. When filling the mould cavity with foam particles, the desired pressure is set.

The procedure described above can be designed in such a way that the device described is used.

The invention is explained in more detail below using the drawings as examples. The drawings show schematically in:

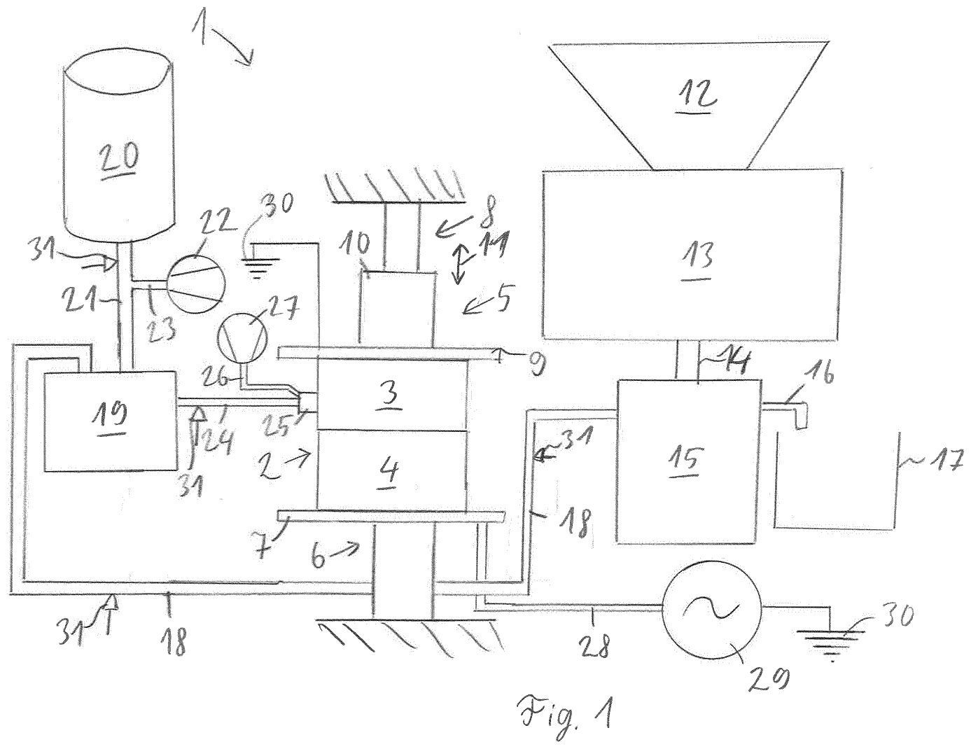

FIG. 1 an apparatus for producing a particle foam part using recycled particle foam material in a block diagram.

The invention is explained below using an example of a device for producing particle foam parts (FIG. 1). Such devices are also referred to as moulding machine 1.

The automatic moulding machine 1 has at least one mould 2, which is formed from an upper mould half 3 and a lower mould half 4. Mould 2 defines a mould space (not shown) for receiving foam particles, which are welded in the mould space to form a particle foam part by adding heat.

Mould 2 is a so-called crack-gap mould, i.e. it is designed in such a way that the two mould halves 3, 4 can be moved apart a little to accommodate foam particles, and then compressed in the filled state by means of a press 5 to press the foam particles in the mould space.

The press 5 has a press table 6 with a support plate 7 and a press plunger 8 with a press plate 9. The press plunger 8 has a cylinder/piston unit 10 with which the press plate can be raised and lowered (double arrow 11).

Furthermore, a container 12 is provided for receiving particle foam parts to be recycled. The container 12 opens with its funnel-shaped and downwardly open underside into a shredding device 13. The shredding device 13 is designed for shredding particle foam parts which are shredded to foam particles with a predetermined size range. The shredded foam particles are unevenly shaped by the shredding process. The maximum expansion of these foam particles is usually in the range of at least 3 mm, especially at least 4 mm and up to a maximum of 10 mm or a maximum of 8 mm. The size of the shredded foam particles can, for example, be controlled by setting a distance between two shredder rollers.

The shredder unit 13 is connected to a sorting unit 15 via a line 14. Sorting devices for sorting foam particles are described in the German patent application DE 10 2019 127 708.6 which has not yet been published. Full reference is made to this patent application. With the sorting device 15 the shredded foam particles can be sorted according to predetermined criteria. One or more sorting criteria may be applied. Foam particles which do not meet the desired criteria are discharged via a discharge line 16 into a collection container 17.

The sorting device 15 is connected to a line 18 with a mixing device 19. Line 18 transports the recycled, shredded foam particles that meet the sorting criteria from sorting facility 15 to mixing facility 19. These foam particles form a regrind.

The mixing device is connected to a storage tank 20 via a line 21.

In pipes 14, 18 the foam particles are transported with a carrier gas. The carrier gas is usually air. This carrier gas can be pressurized with a pump 22. Pump 22 is connected to line 21 via branch line 23.

The storage container 20 is used to provide non-recycled foam particles. These are referred to as originate. The originate is fed to the mixing unit 19 via line 21.

At the mixing device 19 the regenerate and the originate are mixed together in a certain ratio. The mixing ratio is freely adjustable.

The mixing device 19 is connected to a line 24 with a filling injector 25, which opens at one of the two mould halves 3. In this example, the filling injector 25 leads to the upper half of the mould 3.

The filling injector is connected via a compressed air line 26 to a further pump 27, with which air under pressure can be supplied to the filling injector 25, which is referred to as filling air, with which the foam particles from the filling injector 25 are conveyed into the mould space of mould 2 and, if necessary, pressurised.

The support plate 7 is electrically conductive. It is preferably a metal plate. It can, for example, be made of steel or aluminium. The support plate 7 is connected with a coaxial cable 28 to a high frequency generator 29.

The high-frequency generator is designed to generate RF radiation. The high frequency generator is connected to an electrical earth 30.

The press plate 9 is also electrically conductive. It can also be a metal plate, especially an aluminium or steel plate, which is in turn connected to the electrical earth.

The support plate 7 and the press plate 9 thus form capacitor plates, between which a high-frequency field or RF radiation can be applied with the high-frequency generator 29.

The two mould halves 3, 4 are made of a material which is essentially transparent to RF radiation. This material is for example polytetrafluoroethylene (PTFE), polyethylene, especially UHMWPE or polyetherketone (PEEK).

Optionally, at one or more points on the lines 18, 21 and 24, a nozzle 31 may be provided to supply water or another fluid. The water may be supplied as liquid or steam.

The addition of fluid may be designed on the one hand to facilitate the movement of foam particles in the line. such foam particles have a tendency to clump together. If they are wetted on the surface with a fluid, e.g. water, then this tendency is reduced, and conveyance is more reliable. In addition, such fluid may be used as a heat transfer medium in the welding of foam particles. Certain plastic materials, e.g. polystyrene (ePS) and polypropylene (ePP), absorb electromagnetic radiation to only a limited extent. The heat transfer medium is able to absorb the electromagnetic radiation in the mould cavity and transfer it to the foam particles. If materials which, from the start, absorb electromagnetic radiation well are used, then the addition of a heat transfer medium is not necessary.

The following procedure can be carried out with this automatic moulding machine 1:

Particulate foam parts to be recycled are placed in the container 12 from where they are transported to the shredder 13. In the shredding facility 13 they are shredded to foam particles. The foam particles are shredded to a predetermined size, which is adjustable. This regrind is fed to the sorting device 15. With the sorting device 15, impurities or foam particles which do not meet predetermined criteria are sorted out. These criteria can be of various types, such as size, shape, colour, density. Magnetic particles can also be filtered out.

The regenerate prepared in this way is fed via line 18 to the mixing device 19, in which the regenerate can be mixed with the originate in a predetermined ratio. The mixing ratio can be set as desired. The share of originate can also be 0%.

The foam particles are fed from the mixing device 19 to the moulding tool 2. The carrier gas is pressurized by means of pumps 22, 27 so that the foam particles are fed under pressure into the mould space.

During the feeding of the foam particles the two mould halves 3, 4 are pulled apart. After the mould space is filled with foam particles, the two mould halves 3, 4 are pressed together a little by means of the press 5, which reduces the mould space and increases the pressure on the foam particles in the mould space.

The high-frequency generator 29 applies RF radiation to the pressurized foam particles so that the foam particles are heated and welded together.

The RF radiation heats the foam particles in the mold cavity and is heated from the inside out, as they either directly absorb the RF radiation or a heat transfer medium, such as water, is added to them, which absorbs the RF radiation and transfers it to the foam particles.

It is not necessary for steam to be supplied to the mould 2 from the outside to weld the foam particles together. Pressurizing the foam particles in the mould cavity does not impair the heat supply by electromagnetic radiation in any way.

The combination of electromagnetic radiation and the application of pressure to the foam particles in the mould space thus permits the welding of foam particles with a high proportion of regenerated material. Examples are explained in more detail below.

Within the scope of the invention, the above example can be modified in many different ways. For example, it is sufficient to provide only a pump or a press to apply pressure. It is not necessary to fill the foam particles with a pump under pressure and then compress the mould using the press. However, the combination of pressure filling by means of a pump and compression of the crack gap by means of a press allows a high pressure to be applied in the mould cavity.

In the context of the invention, it is also not necessary for the mould halves to be transparent to the electromagnetic waves. The mould halves can also be made of metal and act as capacitor plates themselves. If both mould halves are electrically conductive, however, they must be insulated from each other.

### EXAMPLES

Plates with the dimensions 1000×500×60 mm (=30 litres) were produced. Both the originate and the regenerate were foam particles made of ePS. During filling, the tool was opened by a crack gap of 9 mm. The expanded volume of the mould chamber was 34.5 litres.

The foam particles were put under pressure by the moving together of the mould halves.

Plates were produced with a proportion of regrind of 0%, 10%, 20%, 30%, 40%, 50%, 60%, 70%, 80%, 90% and 100%.

Water was added as heat transfer medium. The amount of water was between 150 ml and 250 ml. The greater the amount of regenerate, the higher the amount of water added.

All plates could be welded. The surface of panels containing 70% or more regrind was slightly rougher and contained much more residual moisture, which remained in the open-pored foam particles of the regrind.

Sheets with up to 60% regrind fulfilled all quality requirements and are hardly distinguishable from sheets without regrind.

### LIST OF REFERENCE NUMBERS

1 automatic moulding machine
2 moulding tool
3 upper mould half
4 lower mould half
5 press
6 press table
7 support plate
8 press punch
9 press plate
10 cylinder/piston unit
11 double arrow
12 bins
13 shredding facility
14 line
15 sorting device
16 discharge line
17 collecting container
18 line
19 mixer
20 storage tank
21 line
22 pump
23 branch line
24 line
25 filling injector
26 pressure vessel
27 pump
28 coaxial cable
29 high-frequency generator
30 electrical earth
31 nozzle

1. Method for producing a particle foam part, comprising the steps of
feeding foam particles into a mould space of a mould,
welding the foam particles in the mould space under application of a predetermined pressure,
wherein the foam particles comprise a proportion of at least 10% by weight of recycled, shredded foam particles and the welding of the foam particles is effected by means of electromagnetic waves.

2. Method according to claim 1,
characterized in that the proportion of recycled, shredded foam particles is
at least 20% by weight and in particular at least 30% by weight or at least 50% by weight or at least 70% by weight.

3. Method according to claim 1, characterized in that the predetermined pressure in the mould space is at least 2 bar, in particular at least 3 bar and preferably at least 5 bar.

4. Method according to claim 1, characterized in that the foam particles are based on polystyrene (ePS), based on polypropylene (ePP), based on polyurethane (eTPU), based on polyether block amide (ePEBA), based on polylactate (PLA), based on polyamide (ePA), based on polybutylene terephthalate (ePBT), based on polyester ether elastomer (eTPEE) or based on polyethylene terephthalate (ePET). (of expandable thermoplastics)

5. Method according to claim 1, characterized in that a heat transfer medium is applied to the foam particles during welding by means of electromagnetic waves.

6. Method according to claim 5,
characterized in that the heat transfer medium is a liquid, such as water.

7. Method according to claim 1, characterized in that the foam particles are welded by means of electromagnetic waves without the addition of a heat transfer medium.

8. Method according to claim 1, characterized in that recycled, shredded foam particles and non-recycled and non-shredded foam particles are mixed by means of a mixing device in a predetermined ratio and fed to the moulding tool.

9. Method according to claim 1,
characterized in that recycled particle foam material is shredded and then fed to the mould space.

10. Method according to claim 1,
characterized in that the particle foam part is made solely from foam particles.

11. Apparatus for producing a particle foam part comprising
a mould defining a mould space,
means for applying a predetermined pressure to foam particles in the mould space, and
a generator for generating electromagnetic waves for welding the foam particles in the mould space,
characterized in that
a mixing device for mixing recycled, shredded foam particles and non-recycled and non-shredded foam particles and/or a shredding device for shredding foam material to be recycled is provided.

12. Apparatus for producing a particle foam part according to claim 11, comprising
a mould defining a mould space,
means for applying a predetermined pressure to foam particles in the mould space, and
a generator for generating electromagnetic waves for welding the foam particles in the mould space,
characterized in that
a sorting device for sorting shredded foam particles is provided.

13. A method according to claim 1,
wherein an apparatus for producing a particle foam part is used, wherein this apparatus comprises
a mould defining a mould space,
means for applying a predetermined pressure to foam particles in the mould space, and
a generator for generating electromagnetic waves for welding the foam particles in the mould space,
a mixing device for mixing recycled, shredded foam particles and non-recycled and non-shredded foam particles and/or a shredding device for shredding foam material to be recycled is provided and/or a sorting device for sorting shredded foam particles is provided.

14. Particle foam part,
characterised in that
it is produced by a method according to claim 1.

15. Apparatus for producing a particle foam part comprising
a mould defining a mould space,
means for applying a predetermined pressure to foam particles in the mould space, and
a generator for generating electromagnetic waves for welding the foam particles in the mould space,
characterized in that
a sorting device for sorting shredded foam particles is provided.
